(19) United States
(12) Patent Application Publication
(10) Pub. No.: US 2009/0136701 A1
(43) Pub. Date: May 28, 2009

(54) STRETCH SLEEVE LABEL

(75) Inventors: Michael Speeney, Newtown, PA (US); Bruce J. Hillemann, Yardley, PA (US); Joseph DeRiggi, Levittown, PA (US)

Correspondence Address: KLEHR , HARRISON ET AL, 260 S. BROAD STREET, PHILADELPHIA, PA, 19102, US

(73) Assignee: MRI Flexible Packaging Co., LP, Newtown, PA (US)

(21) Appl. No.: 12/275,795

(22) Filed: Nov. 21, 2008

Related U.S. Application Data
(60) Provisional application No. 60/989,648, filed on Nov. 21, 2007.

(51) Int. Cl. B32B 3/10

(52) U.S. Cl. 428/43

(57) ABSTRACT

A stretch sleeve label for attachment to a container is provided. The label contains at least one point of weakness configured so that the label can be easily removed by beginning to separate the label into pieces at or near the point of weakness. When removed at the point of weakness, the label is removed without any substantial portion of the label or any adhesive on the container.

### PRIORITY

This application claims priority to U.S. provisional application Ser. No. 60/989,648, filed Nov. 21, 2007.

### BACKGROUND OF THE INVENTION

The present invention relates in general to products and methods for improving recycling efforts and in particular to labels used in connection with recyclable containers.

Commercial recycling of post-consumer plastic bottles and like containers typically involves the removal of labels from the bottles before the bottles can be further processed for re-use. Labeled bottles usually arrive at a processing facility in the form of large compacted bales that contain many contaminants, such as labels, caps, cap rings, foil and dirt. These contaminants must be separated from the bottle before the plastic from the bottle can be recycled. The labels, whether made of plastic, paper or other material, are almost always glued to the bottles. The presence of substantial amounts of glue securing the label to the bottle presents the need for an expensive and time-intensive delabeling process. The traditional delabeling process typically has two general stages: the first is the loosening and/or releasing of labels from a stream of bottles; and the second is the separation and removal of the labels from the stream of bottles.

While the delabeling process of glued on labels may be done by hand by the commercial recycler, this is an extremely inefficient and expensive option in a large volume commercial operation. Hence, mechanical delabeling processes have been developed, but the label separation efficiencies remain fairly low. The most notable problem remains the inefficiencies in separating the released labels from the bottle stream.

Many different processes have been developed for commercial recyclers, such as those employing high-pressure jets of water or pocketed conveyors for holding and moving individual bottles. While such methods may work with a uniform stream of solid bottles of a specific shape, such as glass bottles, they cannot effectively handle a stream of plastic bottles of various shapes and sizes, many of which are crushed or otherwise deformed and damaged.

Another currently employed process that targets post-consumer plastic bottles typically employs a high rpm (revolutions per minute) drum for aggressively removing labels from the bottles, and some kind of perforated screen for label separation. Such screens sometimes resemble ones used to screen gravel or dirt, namely a long cylindrical shell with perforations thereabout, but designed to have separated labels exit through the perforations and to have the delabeled bottles exit at the far end of the shell. A problem with such perforated shells is that even with short use, the perforations get plugged with labels and plastic bottles, hence requiring either frequent cleaning (which is not practical) or another (secondary) stage of label separation, such as hand sorting of the exiting stream of bottles and labels.

Yet another process employs counter-rotating shakers or shaker tables for label removal, but there is a relatively high loss of bottles into the removed label stream, particularly with those bottles where the labels remain attached and can't be shaken off. Hence, some of the delabeling and removal must usually be supplemented by hand. Further, water removal from the bottles is generally inadequate with such systems.

Other processes separate the label with the use of steam and hot water. Steam alone is sometimes used to minimize or eliminate the introduction of water into the bottles, and hence to minimize or eliminate the need for subsequent water extraction from the bottles. In such systems, a drum rotated at low rpm is employed to agitate the bottles, and to reduce wear and tear on machinery and operating costs. A distinct label separation stage is used after the label release stage to separate the labels from the bottles. The separation stage employs a series of rollers, rather than a perforated drum or shaker, to urge the labels away from the stream of bottles and labels exiting the removal stage. Preferably the series of rollers should allow the labels to be discarded below the rollers and the delabeled bottles to be substantially de-watered and transported over the rollers for further processing.

Several patents are directed to machines for removing labels from bottles/containers using various methods such as high-pressure fluid jets (U.S. Pat. Nos. 5,685,053, 5,373,618), and cutter heads (U.S. Pat. Nos. 5,317,794, 5,236,133). However the different size and shape of the containers makes this a very inefficient and difficult process for commercial recyclers. Specifically, the machine must be set up to match the particular size and shape of the containers to be processed by it. Wrap-around-type labels that use an adhesive can be removed using systems employing a chemical bath, such as that disclosed in U.S. Pat. No. 5,679,210.

As distinguished from the present invention, many of the prior art commercial systems require large capital investments and complicated machinery to set up, maintain and operate.

U.S. Pat. No. 5,679,210 discloses a simple hand held safety knife that will aid in the removal of labels from a recyclable container. However, the knife presents some degree of danger, and labels may still contain adhesive and are therefore not perfectly removed, resulting in contaminants remaining with the bottle.

Today, there is a growing environmental concern amongst consumers regarding the depletion of natural resources. There in is an increased awareness and interest in recycling from the consumer perspective, prior to products entering into the post-consumer recycling process, to preserve natural resources and to help improve recycling efforts. Industries that rely on recyclable containers, including bottles, should be poised to seize the assistance of consumers and provide them with products and systems that improve the efficiency and effectiveness of recycling efforts.

What is therefore desired is a novel, substantially adhesive-free label that can be easily removed by the consumer, before disposing of the container in a recycle bin, or by the recycler, which would thereby increase the quality of the plastic resins recycled, thus making the recycling effort more economically feasible. More specifically, in order to increase the quality of the recycled plastic resin, it is desirable to remove of as much of the contaminants associated with the container as possible prior to submitting the containers to a commercial recycler. Labels typically glued onto containers and bottles are a form of contaminant since the ink contained in or on the label contaminates the recycled plastic. The glue or adhesive is an additional contaminant. The introduction of labels, adhesives, and glues into the post-consumer commercial recycling process lowers the quality of the recycled plastic and the value of the recycling efforts.

### SUMMARY OF THE INVENTION

As described below the present invention includes a stretch sleeve label for attachment to a container, comprising: a first point of weakness configured to facilitate removal of said label from said container. The first point of weakness can be a first perforated line positioned at an angle not parallel to nor perpendicular to the horizontal. The first perforated line is preferably positioned at a gentle angle from horizontal.

The stretch sleeve label can further contain a second point of weakness which can be a second perforated line. The two points of weakness can be positioned in the shape of a “V,” an inverted “V,” a sideways “V,” or an open-ended diamond.

The first perforated line can be configured so that it does not reach from the top of the label to the bottom of the label.

Details, objects and advantages of the present invention will become apparent as the following description of the presently preferred embodiments and presently preferred methods of practicing the invention proceeds.

Embodiments of the invention are directed toward stretch sleeve labels, which have a unique advantage in that they do not require adhesive to maintain placement of the label on the container. The labels can be stretched onto the container and sealed onto itself, which permits the label to remain in place without adhesive. The labels also have points of weakness, such as, perforations, notches and/or lines of weakness that facilitate the ease with which the label can be removed, when desired. The points of weakness may be configured in any direction on or in the label and are preferably vertical in orientation but not perpendicular to the top of the label. In a preferred embodiment of the invention, to remove the label, the consumer (or recycler) would pull on a tab connected to the label, and the label would tear along the points of weakness, thereby facilitating removal of the label from the container.

The invention will become more readily apparent from the following description of preferred embodiments thereof shown, by way of example only.

### BRIEF DESCRIPTION OF THE DRAWINGS

FIG. 1 is an exemplar of a preferred embodiment of the present invention, in its state prior to application to a bottle.

FIG. 2 is an exemplar of an alternative embodiment of the present invention, in its state prior to application to a bottle.

FIG. 3 is an exemplar of another alternative embodiment of the present invention, in its state prior to application to a bottle.

FIG. 4 is an exemplar of yet another alternative embodiment of the present invention, in its state prior to application to a bottle.

### DETAILED DESCRIPTION OF THE PREFERRED EMBODIMENT

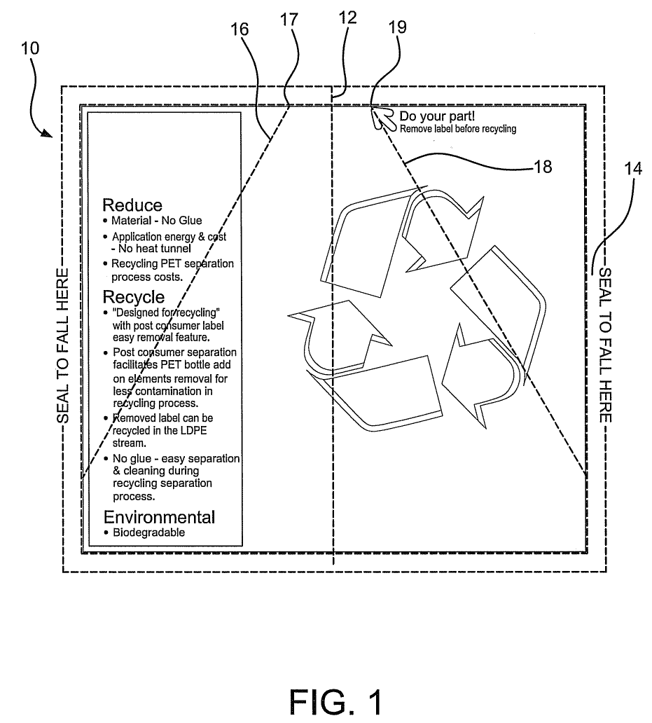

Referring to FIG. 1, there is shown a flattened out version of a stretch sleeve label 10 according to an embodiment of the invention. Label 10 is manufactured in a round form from a continuous web according to methods well-known in the art. The web is folded along the center line 12 and then slit sealed in the seal area 14 (ie. where it says “seal to fall here”) by methods which are also well-known in the art. The points of weakness are indicated by lines of weakness 16 and 18, which can be perforations or notches.

In placing the label on a container, the round form label 10 is stretched circumferentially and placed into position on the container. As such, perforations perpendicular to the label would typically be thought of as to make the label unusable, since such perforations may cause the label to separate during the stretching process. As such, the shape and location of the points of weakness are determined by the artwork printed on the label, circumference of the label, the degree of stretching required, the thickness of the label, and the material used for the label.

In order to determine the shape of the lines of weakness, according to a preferred embodiment, the aspect ratio of the container circumference and the label length from top to bottom is considered. If A=Circumference/label height. When the aspect ratio approaches a value of 3.5 to 4 the shape of the lines of weakness are preferably changed from a simple V or an inverted V to a shape that will allow the label to be easily and entirely removed. A sideways V or an open ended diamond shape, as discussed below, are examples of such shapes. The design of the lines of weakness should be tailored only if the thickness of the label becomes thicker than normal 2 mil label or the tear resistance of the film is increased to a point that the film does not want to tear easily.

Returning now to FIG. 1, when situated on a container, the lines of weakness 16 and 18 preferably form an inverted “V” shape having a left top point 17 and a right top point 19. Although the embodiment depicted in FIG. 1 shows an inverted “V” shape, any known shape having lines of weakness to facilitate removal of the label from a container are contemplated by the invention.

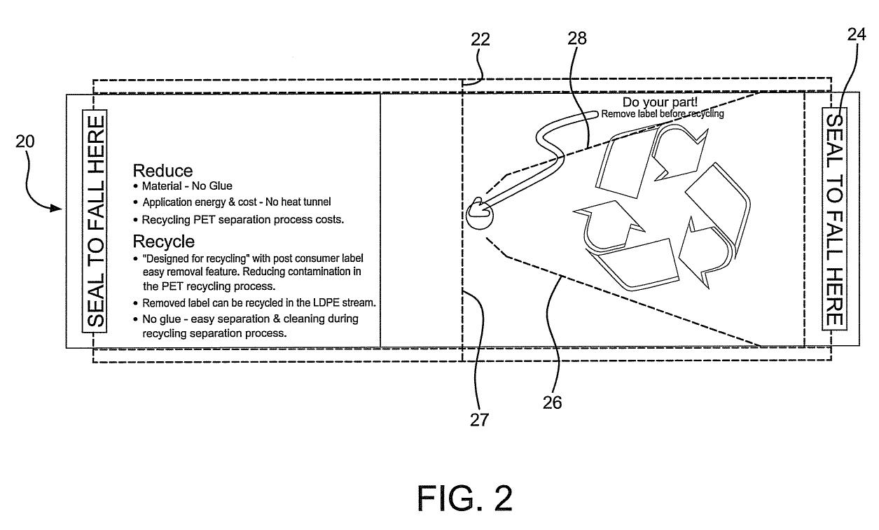

In a preferred embodiment of the invention depicted in FIG. 1, lines of weakness 16 and 18 do not span from the top of the label to the bottom. However preferably, the label, due to its blow up ratio, will tear at approximately 30 degrees from the vertical. Once the label begins to tear along the lines of weakness, it will continue to tear to the bottom portion of the label. The invention contemplates embodiments with points of weakness located at several different angles from horizontal other than those shown in FIGS. 1 and 2. Most preferably, gentle angles from horizontal are desired.

To remove the label 10 depicted in FIG. 1, the consumer would pull on the left top point 17 or right top point 19, causing the label to tear along the lines of weakness 16 or 18.

In another embodiment of the invention, as shown in FIG. 2, the apex of the “V” can be rotated 90 degrees from the top of the label. In this alternative embodiment, the label 20 has a center line 22 and a seal area 24. Lines of weakness 26 and 28 are situated in a sideways “V” shape, so that the apex of the “V” 27 is substantially near the centerline of the label.

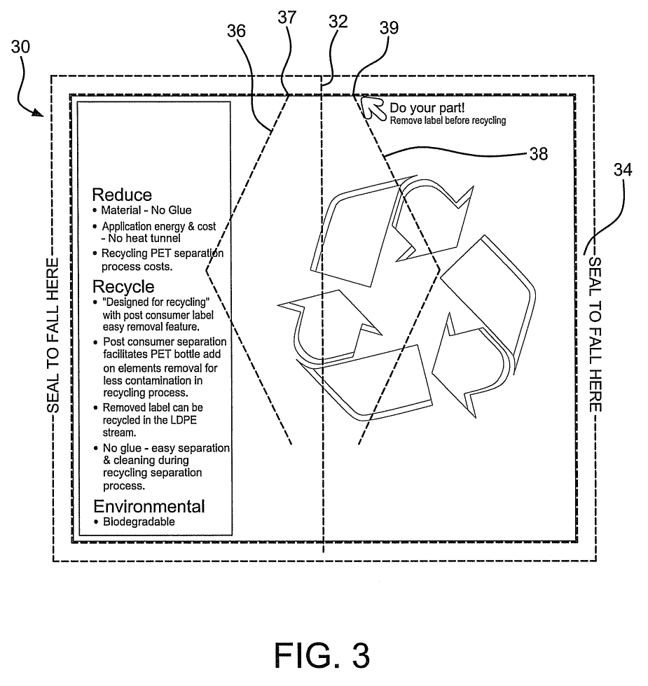

Depending upon the circumference of said label the lines of weakness might be configured so that they form an open ended diamond rather than a “V,” as shown in FIG. 3. In FIG. 3, the label 30 has a center line 32 and a seal area 34. Lines of weakness 36 and 38 are situated in an open ended diamond shape, having a left top point 37 and a right top point 39. To remove the label 30 depicted in FIG. 3, the consumer would pull on the left top point 37 or right top point 39, causing the label to tear along the lines of weakness 36 or 38.

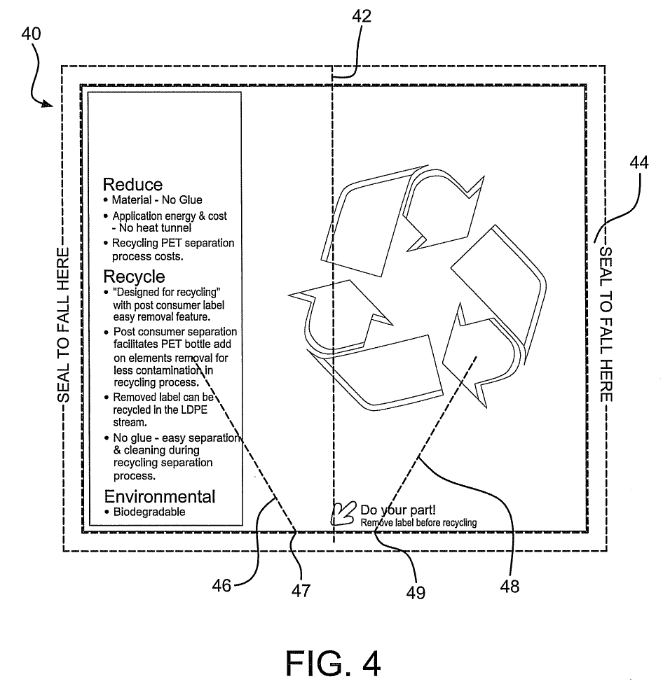

In yet another embodiment of the present invention, the inverted “V” shape of FIG. 1 may be inverted, forming a standard “V”, with the apex of the “V” located at the bottom of the label, as shown in FIG. 4. Label 40 in FIG. 4 has a center line 42 and a seal area 44. Lines of weakness 46 and 48 are situated in a “V” shape, with left bottom point 37 and right bottom point 49. To remove a label with a “V”, the consumer would pull on the apex of the “V” causing the label to simultaneously tear along the lines of weakness.

Labels according to the invention may be comprised of any one or a combination of the following types of plastic resins Low Density Polyethylene (LDPE), Linear LDPE (LLDPE), Hexane LLDPE, Butene LLDPE, Metalacene+LDPE & LLDPE, LDPE highly extensible film, or any other material known in the art for labels that are used on containers. Preferably, labels according to the invention comprise materials having high slip additives and antiblock agents. Use of such materials permits attachment to containers without the use of adhesive.

Although the invention has been described in detail for the purpose of illustration, it is to be understood that such detail is solely for that purpose and that variations can be made therein by those skilled in the art without departing from the spirit and scope of the invention as claimed herein. For example, points of weakness in formations other than those described in detail herein are considered.

We claim:

1. A stretch sleeve label for attachment to a container, comprising:
a first point of weakness configured to facilitate removal of said label from said container.

2. The stretch sleeve label of claim 1, wherein said first point of weakness comprises a first perforated line positioned at an angle not parallel to nor perpendicular to the horizontal.

3. The stretch sleeve label of claim 2, wherein said first perforated line is positioned at a gentle angle from horizontal.

4. The stretch sleeve label of claim 2, further comprising a second point of weakness, wherein said second point of weakness comprises a second perforated line.

5. The stretch sleeve label of claim 4, wherein said first point of weakness and said second point of weakness are positioned substantially in the shape of a “V.”

6. The stretch sleeve label of claim 4, wherein said first point of weakness and said second point of weakness are positioned substantially in the shape of an inverted “V.”

7. The stretch sleeve label of claim 4, wherein said first point of weakness and said second point of weakness are positioned substantially in the shape of a sideways “V.”

8. The stretch sleeve label of claim 4, wherein said first point of weakness and said second point of weakness are positioned substantially in the shape of an open-ended diamond.

9. The stretch sleeve label of claim 2, wherein said first perforated line does not reach from the top of said label to the bottom of said label.
